(19) United States
(12) Patent Application Publication
(10) Pub. No.: US 2007/0233527 A1
(43) Pub. Date: Oct. 4, 2007

(54) SYSTEM AND METHOD OF CONVERTING A BUILDERS RISK INSURANCE POLICY TO A HOMEOWNER'S INSURANCE POLICY

(76) Inventor: Greg DILLARD, Bethlehem, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/694,258

(22) Filed: Mar. 30, 2007

Related U.S. Application Data
(60) Provisional application No. 60/787,486, filed on Mar. 30, 2006.

(51) Int. Cl. G06Q 40/00

(52) U.S. Cl. 705/4; 705/38

(57) ABSTRACT

An Internet-implemented computer system and method for providing an automated insurance package that starts with builder's risk coverage initiated either by the homebuilder that builds the home or by the lender that finances the home construction. The builder's risk policy converts to a homeowner's insurance policy upon the permanent mortgage loan closing when the new home is complete and ready for occupancy. Preferably, any unearned premium for the time remaining on the builder's risk policy is credited to the premium due on the new homeowner's policy.

### CROSS-REFERENCE TO RELATED APPLICATIONS

This application claims the priority benefit of U.S. Provisional Patent Application Ser. No. 60/787,486 filed Mar. 30, 2006, which is hereby incorporated herein by reference.

### TECHNICAL FIELD

The present invention relates generally to property insurance and, in particular, to systems and methods for administering builder's risk property insurance and homeowner's property insurance.

### BACKGROUND OF THE INVENTION

Since the passage of the Gramm-Leech-Bliley Act (the Financial Services Modernization Act) of 1999, an increasing number of U.S. banks have begun offering investment services and insurance products such as long term care, life, retirement annuity, and equity based products to their affluent clients. Today as many as 50% of these relatively high-commission investment and insurance related sales are driven by referrals from the parent bank's customer base. Cross-referrals are integral to the efficiencies of financial services modernization. However, these profit centers require significant investment in highly trained personnel and regulatory infrastructure to generate the commission/fee income necessary to meet the return-on-investment expectations of the banking industry.

Since 1999, many U.S. banks have become active in acquiring employee benefit and commercial property and casualty insurance agencies rather than attempting to start brand new agencies. These types of insurance agencies are characterized by larger premiums and commissions per transaction and present cross-selling opportunities for the parent bank. However, coordination between banking operations and insurance operations is not very developed, so banking industry referrals generally account for less than 25% of new insurance policies. In addition, purchasing an insurance agency large enough to be viable in the marketplace requires significant investment from the parent bank.

At this point, U.S. banks have begun to examine the problem of how to provide property and casualty insurance to more than about 3%-5% (the current industry average) of their depositors. Personal and small commercial property and casualty insurance transactions are larger in number but significantly smaller in dollar volume per transaction. So selling property and casualty insurance to households and small businesses would be a growth area for banks if they could find an efficient and effective way to cross-sell banking and insurance to these clients.

Accordingly, it can be seen that a need exists for a way to help banks provide property and casualty insurance to a significantly larger percentage of their depositors. In particular, there is a need for an automated referral system and method that will enable banks to sell insurance to households and small businesses. It is to the provision of such a system and method that the present invention is primarily directed.

### SUMMARY OF THE INVENTION

Generally described, the present invention provides a system and method that enable lenders to leverage their existing network of contacts and resources to generate new insurance business. In an example embodiment there is provided a system that is used by lenders and insurers to insure real property. The system includes a computer server that is connected to a communications network such as the Internet. The server hosts a conversion website that is accessible by the lenders and insurers using network-connected user devices such as desktop computers, laptop computers, etc. The server stores files with information on construction loans and permanent loans for the real property, as well as information on builder's risk insurance policies for the construction loans. The construction loans and permanent loans are provided by the lenders, and the builder's risk policies are provided by the insurers. In use, the server receives from one of the lenders (or insurers or a third party user) a selection of an active one of the builder's risk policies, then the server sends an underwriting request to one of the insurers. After the underwriting is completed, the server receives an approval from the underwriting insurer. The server then converts the selected builder's risk policy to a real property insurance policy for the real property.

The conversion includes associating stored information from the builder's risk policy and construction loan, along with addition information such as underwriting information that has been entered into the system, with the converted-to real property insurance policy. For example, the conversion includes changing the named-insured provisions. In particular, the server saves information on a borrower of the construction loan, which borrower was an additional-insured party on the builders risk policy, as a primary-named insured on the real property insurance policy, and saves information on a lender of the construction loan and of a new mortgage loan on the real property, which lender was a first-named insured on the builders risk policy, as a lien holder on the real property. In addition, the server assigns a first unique identifier to the selected builder's risk policy and, as part of the conversion, assigns a second unique identifier to the converted-to real property insurance policy, with the second unique identifier being correlated to the first unique identifier. For example, the real property policy number can be the same as the builder's risk policy number, but with the addition of a suffix such as “-PPP.” Furthermore, as part of the conversion the server calculates a pro-rated unearned premium amount for time remaining on the builder's risk policy, and credits the unearned premium amount to a premium amount due for the real property insurance policy. Moreover, the server saves the converted-to file as “pending” real property insurance policy files after the conversion is requested until the conversion is complete.

The system can be set up for several different ways of initiating of the builder's risk policies that are later converted. In one embodiment, the system is set up to receive a request to initiate the builders risk policy from the lender of the construction loan. Such a system is disclosed in U.S. Pat. No. 6,236,973. In another example embodiment, the system is set up to receive a request to initiate the builder's risk policy from the builder of the home for which the construction loan was made. Such a system is disclosed in U.S. Patent Application Publication No. 2005/0086084. And in still other example embodiments the system is set up to receive a request to initiate the builder's risk policy from the borrower or from another party.

Preferably, the system is set up for use by a parent organization (e.g., a bank) with a lending unit and an insurance unit. In this case, significant efficiencies can be obtained by having the same lending unit issue the construction loan, the mortgage loan, and individual project location certificates/policies under a blanket builder's risk policy, and by having the same insuring unit issue the blanket builder's risk policy and the permanent homeowner's policy, with the lending unit and the insurance unit being affiliated with each other.

In another example embodiment of the present invention, there is provided a method of providing insurance for real property. The method can be performed by a server computer such as than referred to in the just-described embodiment. The method includes the steps of receiving a request for a builder's risk policy on a construction loan for a building on the real property. The construction loan is provided by a lender. The next step is opening a file for the builder's risk policy and associating it with the construction loan. Next is communicating a request for underwriting for a real property insurance policy. Upon underwriting approval, next is receiving an underwriting approval for a real property insurance policy. And next is converting the existing builder's risk policy to a new real property insurance policy for the real property by associating stored information for the builder's risk policy with the converted-to real property insurance policy.

The conversion step includes associating stored information from the builder's risk policy and construction loan, along with addition information such as underwriting information that has been saved on the server, with the converted-to real property insurance policy. In particular, the conversion step includes changing the named-insured provisions and assigning a new policy number that is correlated to the original policy number. Also, the conversion step includes calculating a pro-rated unearned premium amount and crediting it to the premium amount due for the real property insurance policy.

The builder's risk policies that are later converted can be feed into the system in several different ways. One example way is from the lenders, for example, using the system and method disclosed in U.S. Pat. No. 6,236,973. Another way is from the builders, for example, using the system and method disclosed in U.S. Patent Application Publication No. 2005/0086084. And still another way is from the borrower or from another party.

In another aspect the present invention includes a computer-readable medium storing instructions that, when executed on a programmed processor, carry out the method just described. The computer-readable medium can be any type of commercially available magnetic, optic, etc. storage device, and can be read by the server's processor to carry out the conversion method described above.

The specific techniques and structures employed by the invention to improve over the drawbacks of the prior systems and methods and accomplish the advantages described herein will become apparent from the following detailed description of the example embodiments of the invention and the appended drawings and claims.

### BRIEF DESCRIPTION OF THE DRAWINGS

FIG. 1 is a functional block diagram of a system for converting a builder's risk insurance policy to a homeowner's insurance policy according to an example embodiment of the present invention.

FIG. 2 is a flow diagram of an example method of intaking new builder's risk policies for conversion using the system of FIG. 1.

FIGS. 3A and 3B are a flow diagram of an example method of converting a builder's risk insurance policy to a homeowner's insurance policy using the system of FIG. 1.

FIG. 4 is a flow diagram of an example premium pro-rating method of the conversion method of FIGS. 3A and 3B.

FIG. 5 is an example “List Loans” screen shot of the conversion system and method, showing a list of files for builder's risk policies to be converted.

FIG. 6 is an example “Convert Quote” screen shot of the conversion system and method, showing data entry fields for underwriting information needed for the converted-to policy.

FIG. 7 is an example “Conversion” screen shot of the conversion system and method, showing a list of files for new homeowner's policies that have been converted or are in the process of being converted.

FIG. 8 is an example Certificate of Property Coverage printout for one of the builder's risk policies.

FIG. 9 is an example Homeowners Policy Declarations printout for one of the converted-to homeowner's policies.

FIG. 10 is an example “Locations” screen shot of a system and method for converting a builder's risk insurance policy to a homeowner's insurance policy according to another example embodiment of the present invention.

### DETAILED DESCRIPTION OF EXAMPLE EMBODIMENTS OF THE INVENTION

The present invention provides a system and method of converting a first insurance policy to a second insurance policy, with both policies insuring the same real property or loans for the same real property. In an example embodiment described and illustrated herein, the system implements a method for converting a builder's risk insurance policy for a home under construction to a separate homeowner's insurance policy for the newly constructed home. The two policies provide collateral for a construction loan for constructing the home and a mortgage loan for the home purchase, and the conversion is performed when the home purchase transaction is closed. It will be understood that the new homeowner's policy is a separate policy that takes effect when the builder's risk policy expires, and the term “conversion” is not meant to imply otherwise. In addition, the term “real property” as used herein refers to improved real property including land and structures built on the land.

The system takes advantage of the integral role that lenders play in the transfer of ownership of real property. The vast majority of real property purchases are financed with lenders providing most of the purchase money that enables the transfer of ownership to take place. With the implementation of the Gramm-Leach-Bliley Financial Services Modernization Act of 1999, lenders can now provide insurance protection to U.S. consumers. The system enables lending institutions to offer insurance coverage when extending credit to a borrower to purchase real property. In this way, lenders can use the system to leverage their real estate lending activity into increased non-interest income by providing comprehensive insurance benefits at reduced costs to their existing depositor customer base. It will be understood that the system can be used by lenders when extending credit to a borrower to build a new building or structure, purchase an existing building or structure, refinance an existing building or structure, or renovate an existing building or structure, whether the property is commercial, residential, or both.

Typically, when the home construction is completed and the mortgage loan closes, the builder's risk policy expires and the borrower/homeowner replaces it with a conventional homeowner's policy issued by another insurance company, with the borrower/homeowner contacting a number of insurance agents for quotes and choosing from among them. Instead, the system allows the borrower/homeowner to have the builder's risk policy automatically converted to a discounted homeowner's policy preferably issued by the same lender who issued the builder's risk policy, the construction loan, and the mortgage loan. The builder's risk policy is typically one “covered location” under a lender's blanket builders risk policy, and in the conversion process each of the “covered location” policies breaks off into an individual, separate homeowner policy issued directly to the borrower/owner client. The converted policy is preferably a comprehensive personal protection policy with coverage parts for the client's homeowner exposure and optionally for automobile, recreational vehicle, personal umbrella liability, etc.

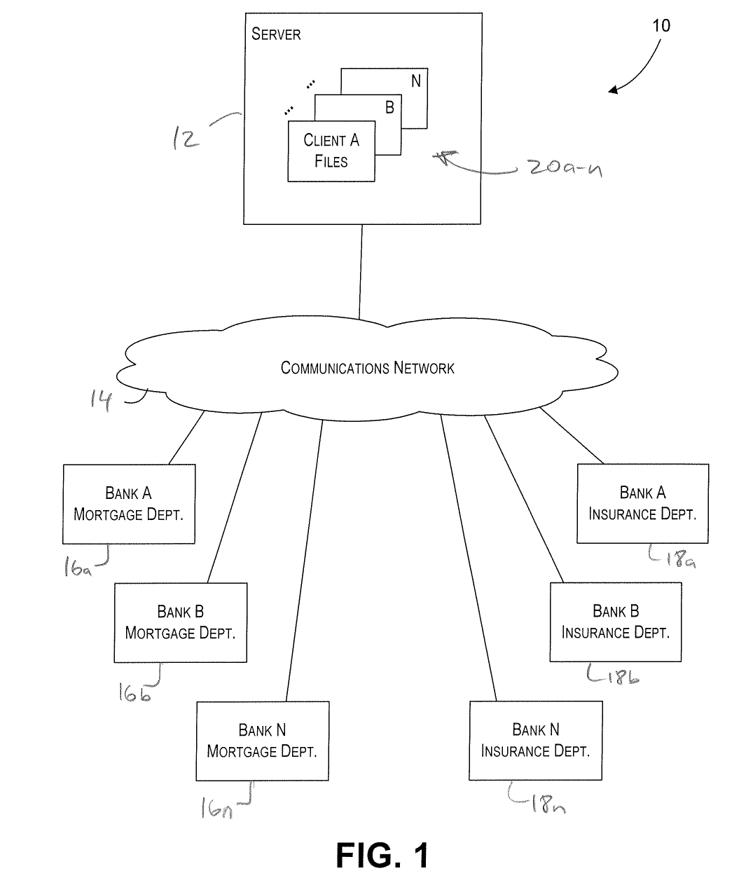

Referring now to the drawings, FIG. 1 is a functional block diagram of a system 10 according to an example embodiment of the present invention. The system 10 includes a server 12 connected to a communications network 14 that can be accessed by user interface devices of lender mortgage departments 16a-n and lender insurance departments 18a-n. Client files 20a-n are stored in one or more databases on the server 12 and are accessible by the user interface devices of mortgage departments 16a-n and insurance departments 18a-n. In a typical commercial embodiment, the server 12 is provided by a remote bank of conventional server computers with programmed processors and storage media that host a website for administering the conversion method. The client files 20a-n include borrower/owner client information for the personal and/or commercial clients, for example, an individual who is both the borrower of the loan and the purchaser/owner of the home. In addition, the communications network 14 is preferably a global computer network such as the Internet, although in some applications the system 10 could be implemented using a WAN, LAN, or other network. The user devices 16a-n and 18a-n are typically desktop computers, laptop computers, handheld computers, PDA's, web-enabled phones, and/or the like.

For maximum efficiency, the mortgage department 16a and the insurance department 18a are preferably organizationally related (e.g., part of the same bank or otherwise affiliated), though they need not be physically located together. The same is true for mortgage department 16b and insurance department 18b, up through mortgage department 16n and insurance department 18n. The example system 10 of FIG. 1 depicts such an arrangement with, for example, Bank A providing the construction loan, the mortgage loan, the builder's risk insurance policy, and the homeowner's insurance policy for one home location. In a typical commercial embodiment, the system 10 is administered by a third party such as an insurance broker or agency for use by a number of banks that provide lending and insurance services (and/or insurance companies that provide lending and insurance services). In an alternative embodiment, the system is administered by a bank (or an insurance company) for its exclusive use (e.g., only Bank A can access the system, not Banks B-N), with the system implemented on the Internet with access restricted to bank-authorized users, or implemented on a private internal network of the bank.

In another alternative embodiment, the system can be used effectively, though perhaps not as efficiently, by separate, unaffiliated mortgage and insurance organizations, with the system implemented on the Internet and administered by an insurance broker or agency, by one of the mortgage or insurance organizations, or by another entity. For example, the system can be used to convert a builder's risk policy issued by one insurance company to a homeowner's policy issued by a different insurance company. Furthermore, the construction loan and the mortgage loan can be bundled together as a two-part construction-to-permanent loan issued by the same lender, or they can be two separate loans with the lender of the construction loan and the lender of the mortgage loan being different banks. Accordingly, as used herein the terms “mortgage department” and “insurance department” are intended to be broadly construed to generally include all lenders of construction loans, mortgage loans, etc. and all insurers of building construction (and loans therefor), completed buildings, etc., respectively, whether they are organizationally related or not, and if they are organizationally related then regardless of whether the parent organization is a lending institution or an insurance company. In addition, the terms “mortgage department,” “lending unit,” and “lender” are used herein synonymously, as are the terms “insurance department,” “insuring unit,” and “insurer.” Furthermore, the terms “insurance department” and “insurer” are used herein broadly to include an insurance carrier or an insurance department within a lending or other institution, with or without an insurance brokerage or agency. This is because the system could be administered directly by an insurance carrier or an insurance department within a lending institution without the involvement of a separate insurance agency or brokerage, and the method steps described as carried out by an insurance agency or brokerage could be done directly by an insurance carrier, an insurance department within a lending institution, etc.

Before using the system 10, each bank (or other user organization) registers by completing an online registration application with organizational information, and registers the individual users in the lending and insurance departments. Such online registration is well known in the art, so details are not provided herein.

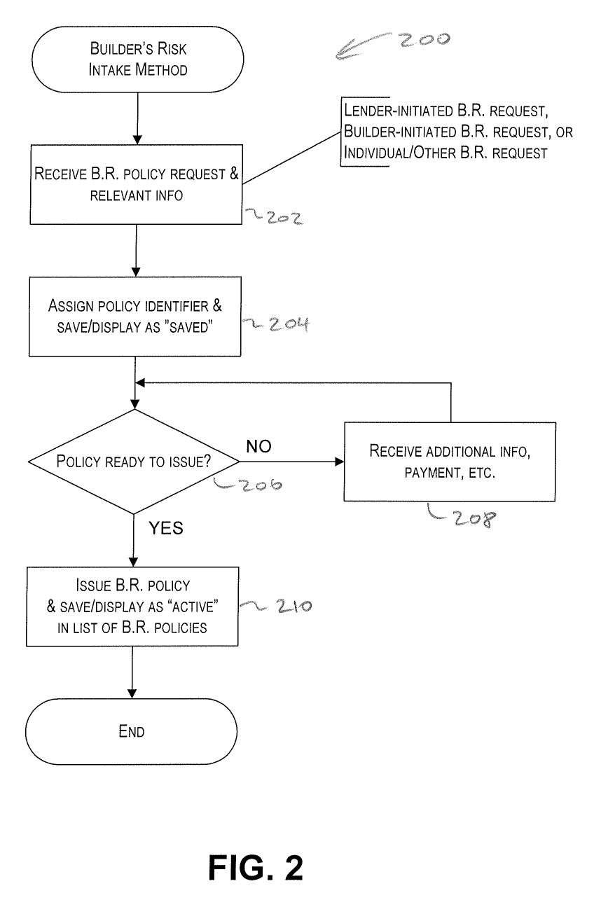

Turning now to FIG. 2, there is shown a method 200 of feeding in the builder's risk policies that can later be converted. At step 202, the server 12 receives a request for a builder's risk policy, generally along with the relevant information on the property, the builder, the lender, and the borrower/owner. In the example embodiment, the request is typically initiated by the lender who is providing the home construction loan being insured. For a lender-initiated policy request, for example, the initial coverage may be provided by a blanket builder's risk insurance policy written with the lender as the initial-named insured, with the borrower clients added as additional insureds at the time their construction loans are closed. The borrower clients pay a fully-earned premium (either annual or for the term of the loan) and their project is insured under an endorsement to the lender's blanket policy, which has a continuous policy term. The borrower client is provided a Certificate of Coverage that includes the lender's blanket policy number with a uniquely numbered suffix designating the borrower's insured project. Builder's risk coverage provided in this way is disclosed in U.S. Pat. No. 6,236,973 and commercially available through Omni Builders Risk, Inc. (Winder, Ga.) at “www.omnibuildersrisk.com,” which patent and website are hereby incorporated herein by reference. Conventional builder's risk policies are initiated by the builder, who purchases a blanket policy for covering a number of construction projects and makes inventory reports regularly (e.g., monthly) to the insurance company providing the coverage and the construction lenders financing the various projects. In the patented lender-initiated builder's risk system, however, the lender issuing the construction loan purchases a blanket policy and adds construction projects (e.g., houses) and builders to be covered by the policy. So the lender is the point of initiation and risk-aggregation of the builder's risk policy. This system is particularly well-suited for use by small builders—those with less than about 25 new housing starts a year.

Alternatively, the system can be adapted to receive a builder's risk policy request that is initiated by the builder who constructs the home the policy covers, an individual (not a professional builder) overseeing the construction of his home, or another entity. An example embodiment for receiving builder-initiated builder's risk policy requests is described below.

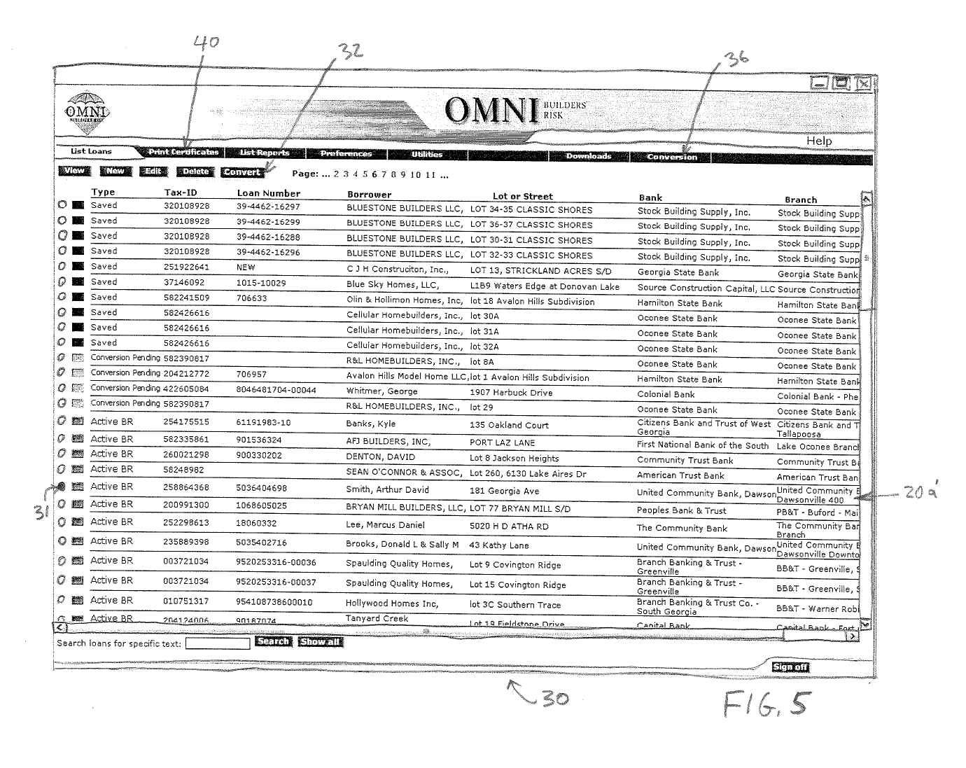

At step 204, the server 12 opens a new loan file 20a, assigns a unique policy identifier (e.g., a policy number) to the file, and saves the received information in the file as a “Saved” type file. (A builder's risk file is herein referred to as a file 20a′, a converted-to homeowner's policy is herein referred to as a file 20a′, and for convenience these are sometimes collectively referred to as files 20a.) Typically, there will be some time before the premium payment is received, or some additional information will be needed, so the policy is not immediately ready to issue. At step 206, if the policy is not yet ready to issue, then the server 12 retains the saved file for a predetermined period of time. If the needed payment and/or information is not received with that time period, the server 12 deletes the saved file and/or archives it. Typically, at step 208 the needed payment and/or information is received within that time period. Once the needed information and payment have been received and the policy is ready to issue at step 206, the server 12 proceeds at step 210 to issue the builder's risk policy and save the file as an “Active BR” type file. Example “Saved” and “Active BR” files are listed in the example screen shot of FIG. 5.

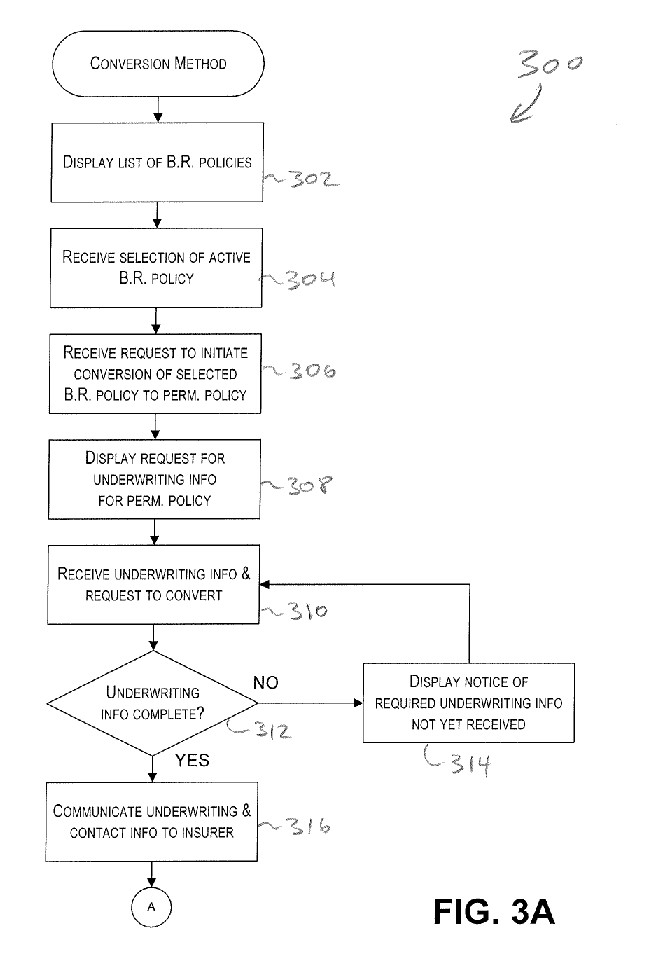

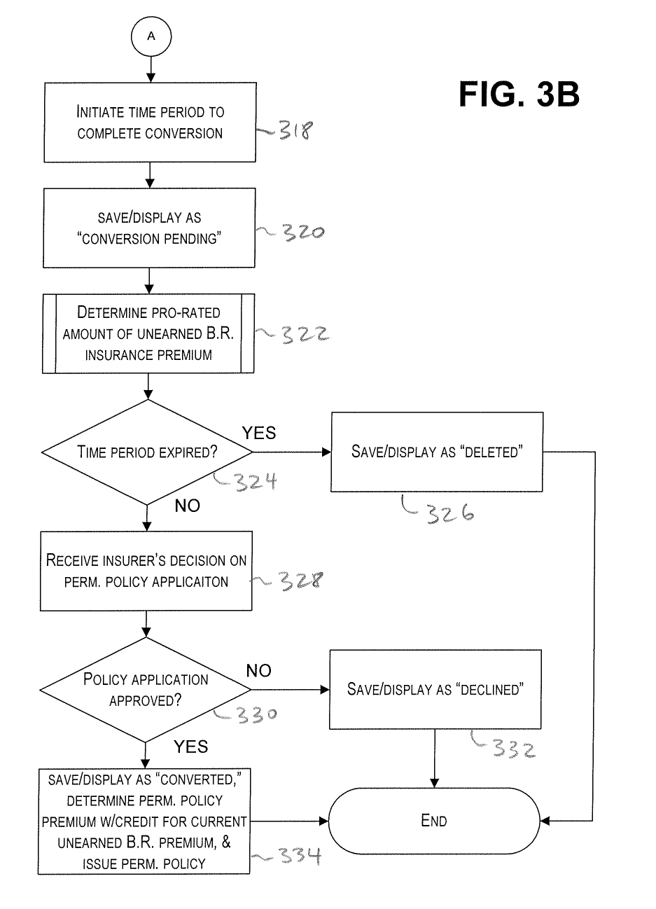

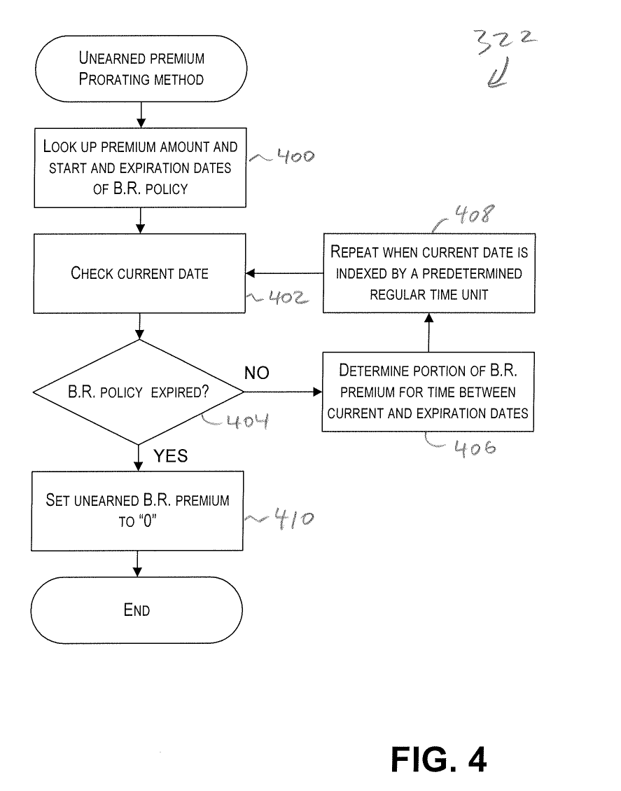

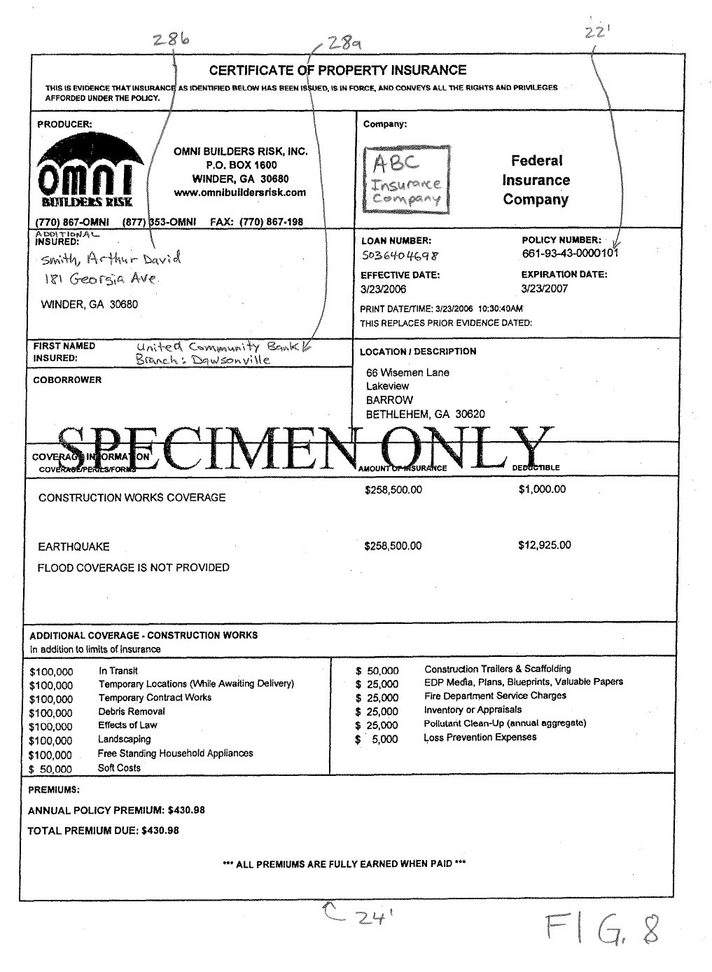

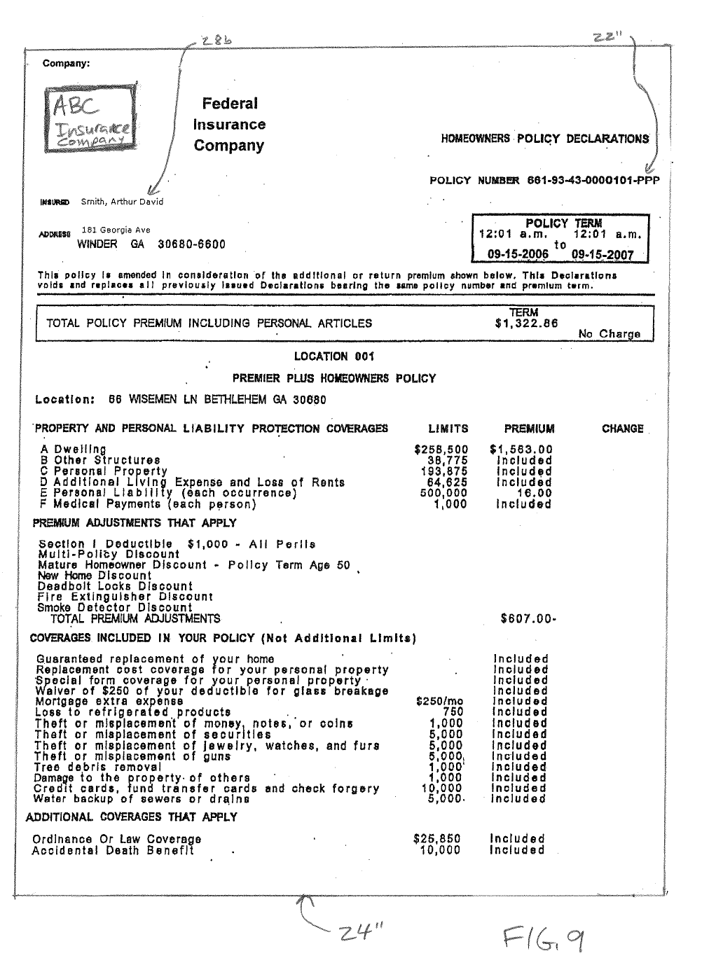

Details of the conversion process 300 will now be described with reference to the flow diagrams of FIGS. 3A, 3B, and 4, the screen shots of FIGS. 5-7, and the printed-out certificates of FIGS. 8 and 9. The conversion process 300 begins with an online user in the mortgage department 16a (e.g., of a bank) utilizing a local user interface device to access the conversion website hosted on the server 12. The server 12 receives from the user device the proper authorization (e.g., user ID and password) for the user, and displays to the user device the authorized pages of the website. It will be understood that the screen shots illustrated in FIGS. 5-7 are representative screen displays included for explanatory purposes only, and are they in no way intended to be limiting of the invention.

At step 302 the server 12 displays a “Loan List” screen 30 (see FIG. 5) on the user device. The Loan List screen 30 includes “Saved” builder risk loan files (the policy has not yet been issued) and “Active BR” loan files, as well as a “Conversion Pending” loan files. Preferably, the lender initiates the construction loan and the builder's risk policy, so all the information on the loan and all the information on the insurance policy are stored in or associated with one file, which may be referred to as the construction loan file (as is the custom for lenders because they think of the insurance as being for the loan) or the builder's risk policy file (as is the custom for builders because they think of the insurance being for the home). The “Loan List” screen 30 includes a “view” button for viewing details of an existing loan and builder's risk policy file, a “new” button for setting up a new loan and builder's risk policy file (e.g., according to the intake method 200), an “edit” button for revising or updating information in an existing file, a “delete” button for deleting an existing file, and a “convert” button for proceeding with the conversion process, as described below.

At step 304 the server 12 receives from the user device a selection of an “Active BR” policy file 20a′. Typically, the lenders have a blanket builders risk policy and add “covered locations” for each new home to be built, and for convenience the term “policy” as used herein includes a stand-alone builders risk policy or one covered location under a blanket builders risk policy. And at step 306 the server 12 receives from the user device a request to initiate the conversion. In the depicted embodiment, the user clicks on a button 31 beside a listed policy file 20a′ to select that policy, then clicks on a “Convert” button 32 to initiate the conversion of the selected policy. (The “Convert” button 32 is similar to the “Renew” button on the “loan list” webpage for the patented lender-initiated builder's risk system described above.) In an alternative embodiment, the lender's core loan processing software electronically interfaces with the conversion website (e.g., via the Internet), and the same user in the bank's mortgage department can initiate the conversion process by using the lender's core loan processing software to access the conversion website.

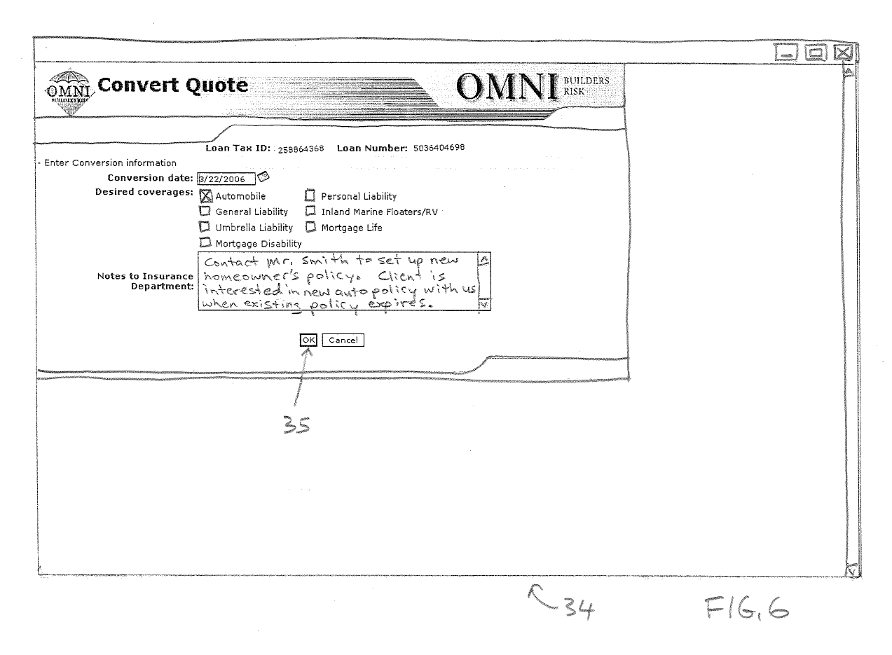

At step 308, the system 10 then displays a “Convert Quote” screen 34 for the user in the lender's mortgage department 1 6a to input information for the selected policy 20a′ and the borrower/owner client that may be useful for the insurance underwriters. In the screen shot depicted in FIG. 6, for example, the “Convert Quote” screen 34 displays a field for entering an estimated conversion date, check boxes for indicating additional coverage types that the client may want to discuss, and a “Notes to Insurance Department” field for entering instructions regarding this client. In addition to the additional coverage types shown in the “Convert Quote” screen 34, the system 10 can be adapted to include data entry screens for optional coverage parts such as structural warranty, mortgage insurance, and title insurance. The “Convert Quote” screen 34 includes an “OK” button 35 that the user clicks on to send the entered information to the server 12. Next, at step 310 the server 12 receives the requested information from the user in the lender's mortgage department 16a. If at step 312 any required information is not received, then at step 314 the system 10 displays to the user in the loan department 16a the “Convert Quote” screen with a notification (e.g., marked in red) of any incomplete fields that are required to be competed (e.g., the estimated conversion date) or any incorrectly entered fields (e.g., an already passed estimated conversion date).

In the example method described herein, the conversion request is entered into the system by the lender. However, the conversion request can alternatively be entered by the insurer or a third party. Or the lender can notify (e.g., by phone) the insurer that a builder's risk policy is available for conversion and the insurer can then initiate the conversion. In any case, the insurer can then enter all of the underwriting information itself.

Once the server 12 has received all of the required preliminary underwriting information at 312, then at step 316 it communicates this information to the insurance department 18a for new business solicitation and underwriting of the policy. In a typical commercial embodiment, the system 10 communicates the underwriting information to the insurance department 18a in an email. The server 12 is preferably set up to automatically generate an email including the message entered into the “Notes to Insurance Department” field and the other data entered into the “Convert Quote” screen 34, as well as an email address of the insurance department, so that all the lender/user has to do is click on “send” to transmit the email. In addition, the email may include contact information (stored on the server 12) for the borrower/owner client and/or additional underwriting information from an automated homeowner's or business owner's underwriting questionnaire. In alternative embodiments, the system communicates the underwriting data in another way, for example, by automatically printing out a hard copy of the data entered into the “Convert Quote” screen 34 for faxing or mailing, or by an SMS message. In any case, the underwriting data for the project is communicated to the insurance department 18a, typically to a licensed insurance agency designated by the lender 16a. This is usually, but not necessarily, a subsidiary or otherwise affiliated insurance agency of the lender 16a.

In the depicted embodiment, the system 10 is set up to allow the mortgage department 16a to enter into the “Convert Quote” screen 34 only those items of underwriting information needed to initiate the builder's risk policy (which information the mortgage department already has). The system 10 is not set up for the mortgage department 16a to enter all of the information needed for underwriting the permanent homeowner's insurance policy and any other insurance policies of interest to the borrower/owner client. This is because, for legal reasons, there is currently the need to limit the amount of underwriting information that a lender without an insurance license can load into the system 10 to only those items of underwriting information needed to initiate the builder's risk policy. (In at least some U.S. states, an insurance license is not required to issue certificates of coverage for individual coverages under a group property casualty insurance written in the name of the lender, but an insurance license is required to write the group property casualty insurance policy and to write individual policies.) This avoids permitting an unlicensed person to “underwrite” other forms of insurance. But when the conversion process 300 is started and the underwriting data is communicated to the insurance department 18a for underwriting of the homeowner's policy, the lender 16a can check the additional coverages that the borrower might be interested in buying. In an alternative embodiment (for implementation upon legal changes permitting its use), the system permits the lender to enter all of the needed underwriting information.

The licensed insurance agent of the insurance department 18a who receives the email with the preliminary underwriting data contacts the borrower/owner client and confirms all the underwriting information, including expiration dates of optional coverage parts, and obtains any additional underwriting information that is needed. Of course, the borrower/owner could decline and obtain the needed homeowner's insurance elsewhere, but with the increased convenience and savings to the borrower/owner a high percentage of them proceed with the process. Then the insurance agent of the insurance department 18a emails (or otherwise communicates) the underwriting information to the insurance carrier of the insurance department with an application for the permanent homeowner's policy.

Preferably, when the lender 16a using an interface device clicks the “OK” button 35 on the “Convert Quote” screen 34, in addition to communicating the preliminary underwriting and client contact data to the insurer 18a, at step 318 the server 12 also initiates a predetermined time window for completion of the conversion process 300. The builder's risk insurance policy 20a′ remains in effect during the time window according to its original terms. In a typical commercial embodiment, the time period is set at 45 days because that is the length of time written into a typical builder's risk form and this time frame works well the vast majority of the time. (The typical builder's risk policy allows occupancy beginning 45 days prior to the permanent loan closing, in other words, the borrower/owner can usually move into the home before the closing but must close within 45 days of moving in). The conversion process 300 can be completed anytime during the time period and as soon as the mortgage loan closes. The actual time it takes to complete the conversion process 300 on the server 12 is just few minutes if the insurance department 18a has all the information it needs to initiate the homeowner policy. The net cost (policy premiums) to the homeowner will vary according to how long it takes to complete the conversion process 300 and how much time remains on the initial builder's risk annual premium, as described in more detail below. The system 10 also automatically prints out for mailing (or otherwise communicates) to the borrower/owner a certified letter of cancellation or non-renewal. This letter documents the date (at the end of the time period) by which the conversion process 300 must be completed and when the builder's risk policy expires.

In an alternative embodiment, instead of initiating a set time period to complete the conversion method 300, the system 10 displays on a data entry screen a required field for entry of the estimated closing date of the home purchase transaction. For example, this field can be included on the “Convert Quote” screen 34 for the lender (or insurer) to input a date, or it can be included on a separate screen. The estimated closing date can be obtained from the borrower/owner client (from the sales contract for the home purchase), for example, when the insurance agent makes contact to confirm the underwriting information. In another alternative embodiment, the system is not set up for receiving an entered date or initiating a time window for completion of the conversion method. However, the administrator of the system (e.g., an insurance agency) preferably sets up a reminder in a tickler file, on a calendar, etc., to make sure the conversion is complete in time for the closing of the home purchase transaction.

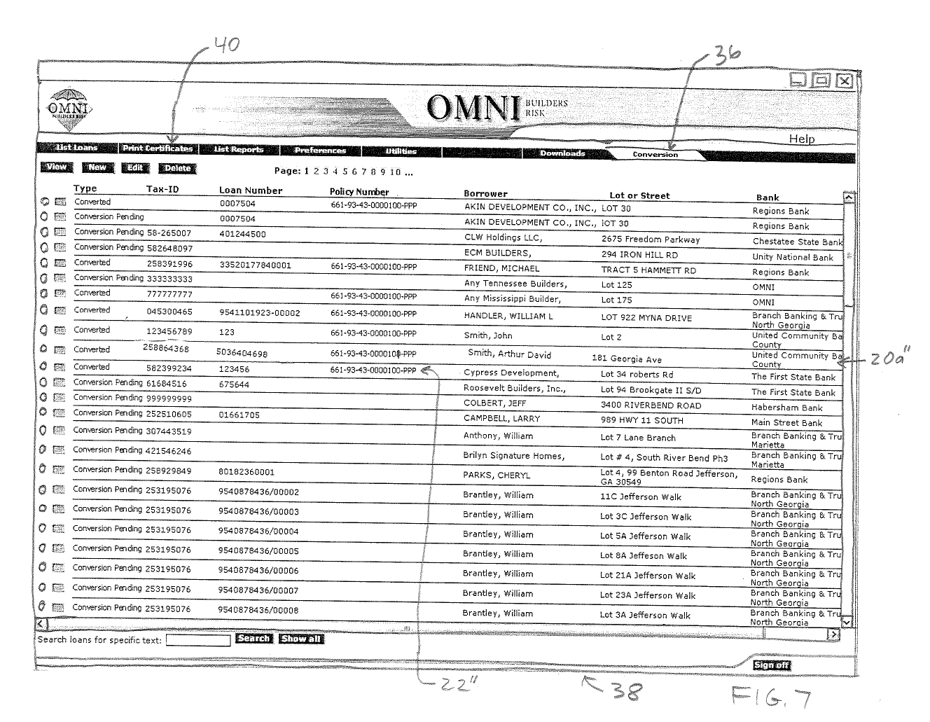

In addition, at step 320 the server 12 automatically makes an entry in the activity log file 20a′ for the loan/policy indicating that a conversion has been initiated and recording the electronic submission of the underwriting information. And the server 12 saves the loan/policy file 20a′ and indicates that the file is now a “Conversion Pending” type on the “List Loans” screen 30 of FIG. 5 and the “Conversion” screen 38 of FIG. 7. If a user in the lender's mortgage department 16a wants to view those loans/policies that are in the 45-day conversion window, as well as the loans/policies that have been converted to homeowner's policies, it clicks on the “Conversion” button 36 in the menu bar of the “Loan List” screen 30 of FIG. 5, and then the “Conversion” screen 38 of FIG. 7 is displayed to the user device by the server 12. The “Conversion” screen 38 lists the “Conversion Pending” loans/policies, as well as the “Converted” loans/policies with their corresponding policy numbers. A “Conversion Pending” loan/policy becomes a “Converted” loan/policy when the homeowner's policy becomes effective. The “PPP” suffix on the “Converted” loan/policy numbers indicates that these are now comprehensive “Personal Protection Policies” including homeowner's and other coverages. The user can then click the select button for any of these loans/policies and click the “View” button to view the activity log file on the selected loan/policy and confirm the insurance coverages provided.

Furthermore, at step 322 the server 12 runs a calculation to pro-rate the unearned premium remaining on the builder's risk policy. Any unearned premium is credited to the borrower's new homeowner's policy at the completion of the conversion process 300. Details of the pro-rating method are provided below with reference to FIG. 4.

If at step 324 the predetermined time period expires without the conversion process 300 being completed, then at step 326 the file is deleted (or archived) at step 326 and the process ends. In this case, a new homeowner's policy is not issued and the original builder's risk coverage expires according to its original terms, though the client could subsequently request the conversion be completed even after the builder's risk policy has expired (there would be a gap in coverage between the expiration of the builder's risk policy and the effective date of the homeowner's policy). Typically, this is not the case. Usually, within a few days the insurance department 18a makes a decision on the policy application and at step 328 the server 12 receives the decision entered by the insurance department.

If at 330 the server 12 receives an entry that the insurance carrier 18a rejected the permanent homeowner's coverage application, then at step 332 the server updates the loan file to “Declined.” The builder's risk policy stays in effect according to its original terms (including the 45-day move-in occupancy clause). To document this, the system 10 automatically prints out for mailing (other otherwise communicates) to the borrower/owner client a Reinstatement Notice stating that the builder's risk coverage remains in effect until it is replaced by another insurance carrier or until the normal expiration of the builders risk coverage part, whichever occurs first. The conversion process 300 then ends.

If at step 330 the insurance application is approved by the insurance department 18a, then they communicate (e.g., via email, phone, fax) an approval notification back to the lender mortgage department 16a, where an online user enters the approval into the system 10. In an alternative embodiment, the lender's core loan processing software electronically interfaces with the conversion website, and the loan approval status is updated on the website directly by the lender insurance agent/department 18a. Or a user in the insurance department 18a can enter the approval directly. In any event, once the status is updated to “Converted,” at step 334 the server 12 makes an entry in the activity file of the loan/policy and saves the file 20a″ as a “Converted” type with the new permanent policy coverage data. Then the server 12 determines the amount of any unearned premium remaining on the builder's risk policy (according to the pro-rating method 400 of FIG. 4) and applies this amount as a credit to the premium due for the new homeowner's policy. The system 10 then issues the new homeowner's policy and emails or otherwise communicates (e.g., prints out for regular mailing) a copy of the homeowner's policy, including a net premium invoice, to the insurance agency 18a and/or the borrower/owner client.

The conversion by the system includes several parts. Preferably, the converted file 20a″is a newly opened file on the server 12 that is populated with information from the file 20a′ on the builder's risk policy and construction loan. In addition, the converted file 20a″ is populated with preliminary underwriting information entered by the lender and/or any additional underwriting information entered by the insurer, for example coverage limits, deductibles, the identification of the property being covered, the distance to the nearest fire hydrant and/or station, the inclusion of a home security and/or fire detection system, etc. Furthermore, the conversion includes changing the named-insured provisions, as described in more detail below. At the conclusion of the conversion, the original policy/loan file 20a′ is archived as an expired file so that it is accessible at a later date for documentation purposes.

The converted policy is preferably similar to the personal package policies currently offered by several insurance carriers. The property coverage part is required coverage on the converted policy, and additional coverage parts such as personal liability, general liability, automobile, inland marine floaters/recreational vehicle, umbrella liability, mortgage life and mortgage disability are optionally available. The coverage parts other than the homeowner portion can remain open until the client's current automobile, recreational vehicle, or personal umbrella insurance is up for renewal, then upon the client's request the files of those coverage parts can be populated with the client's information.

As mentioned above in the conversion method 300, the system 10 enables the borrower/owner client to receive a credit towards the new premium due on the homeowner's policy. When conversion takes place, the term premium for the builder's risk coverage is pro-rated and any unearned premium may be credited towards the premium for the permanent coverage. For a conventional builder's risk policy, the premium is often based on a one-year term. However, often the house (or other construction project) is completed in less than one year. So often a portion of the premium paid to the insurer is not earned, with the exact amount based on how many days remain in the one-year term. For example, in the situation where the builder's risk policy is based on a one-year term and the builder completes the house in eleven months, then there is an unearned premium portion equal to 1/12 of the total premiums paid, and the insurer typically keeps this unearned premium. When using the system 10, however, any unearned premium is credited towards the premium for the permanent coverage. In other words, the builder's risk premium remains fully earned and the credit is applied to the homeowner rates (that are filed and approved by the various Insurance Commissioners) in recognition of the new business acquisition expense savings realized through the conversion process.

With reference to FIG. 4, the pro-rating method 322 will now be described in more detail. At step 400, the server 12 looks up the premium amount, the start date, and the expiration date of the builder's risk policy in the loan/policy file. Also, at step 402 the server 12 checks the current date. Preferably, the server 12 includes a clock feature that can be checked for the current date. If at step 404 the current date is before the expiration date of the builder's risk policy, then at step 406 the server 12 runs a calculation to prorate the amount of the premium corresponding to the amount of time remaining on the policy. The users in the mortgage department 16a or in the insurance department 18a can log onto the conversion website, access the “List Loans” screen 30 of FIG. 5 or the “Conversion” screen 38 of FIG. 7, select one of the “Conversion Pending” loans/policies, and click on the “View” button. Then the new homeowner's policy premium amount due, including the unearned premium credit from the builder's risk policy based on the current date, is displayed to the user (along with other details of the loans and policies). So the users in the mortgage and insurance department 16a and 18a can pass this information on the homeborrower/owner client.

At step 408, when the current date is indexed by one regular predetermined time unit, the server 12 returns to step 402 and repeats the pro-rating process. The time unit is typically set to one day, but it could be set to a week, an hour, or another time unit. If desired, the system 10 can be set up to automatically report to the borrower/owner client (or another party) via daily emails (or other communications) the currently available unearned premium credit. If at step 404 the builder's risk policy has expired, then at step 410 the unearned premium credit for the builder's risk policy is set to zero, and the method ends.

Referring now to FIGS. 8 and 9, there are shown an example “Certificate of Property Coverage” 24′ and an example “Homeowners Policy Declarations” 24″. The “Certificate of Coverage” 24′ is for the policy of file 20a′ under the lender's blanket construction policy, and is printed out by the system 10 when a user selects that policy file and clicks on the “Print Certificates” button 40 on the “List Loans” screen 30. Similarly, the “Homeowners Policy Declarations” 24“is for the converted, separate homeowner's policy file 20a″, and is printed out by the system 10 when a user selects that policy file and clicks on the “Print Certificates” button 40 on the “Conversion” screen 38.

A unique policy number 22′ is associated with the construction loan and policy file 20a″ for a specific construction project under the lender's blanket construction policy. During the conversion process, this policy number 22′ is replaced in the separate permanent homeowner's policy file 20a″ by another unique policy number 22″. The second unique policy number 22″ for the homeowner's policy is preferably correlated to the first unique policy number 22′ for the builder's risk policy. For example, the second unique policy number 22″ may be assigned to be the same as the first unique number 22′ plus a suffix such as “-PPP,” as depicted in FIGS. 8 and 9.

In addition, during the conversion process the named-insured provisions also convert so that the borrower (who was the additional-insured party on the builders risk policy) becomes the primary-named insured, and the lender (who was the first-named insured on the builders risk policy) becomes the lien holder on the home. This named insured conversion takes place because permanent mortgages are eventually bundled and sold to other lenders like Fannie Mae or Freddie Mac. For example, as can be seen in FIGS. 8 and 9, in the file 20a′ for the construction coverage the lender 28a was the first-named insured and the borrower/owner client 28b was an additional insured. However, in the file 20a″ for the homeowner's coverage the borrower/owner 28b is now designated as the “Named Insured” and the lender 28a is designated as “Loss Payee” or “Mortgagee.” The information on the lender 28a, the borrower/owner 28b, etc., is encrypted and securely stored on the server 12 for populating various webpages.

Furthermore, as can be seen in the screen shots of FIGS. 5 and 7, the system 10 includes additional features for the convenience of the users in the mortgage and insurance departments 16a and 18a. When users click on the “List Reports” button, the system 10 displays a screen with a list of the available reports that can be run on the loan/policy files 20a stored on the server 12. The system 10 can be set up with standardized reports, and custom reports can be generated if desired. When users click on the “Preferences” button, the system 10 displays a screen where the users can enter preferences such as a user-defined default for the user's state (e.g., Georgia) that will populate new files 20a when they are set up. When users click on the “Utilities” button, the system 10 displays a menu of screens for various features such as setting up new banks, insurance companies, and builders in the system for regular use, editing rates, user training, and updating risk data (zip codes changed to higher risk for earthquakes or floods). And when users click on the “Downloads” button, the system 10 displays a screen with a list of downloadable forms such as a form for banks to add new users, a form for requesting increased coverage limits (for larger-type risks), and a printable checklist for obtaining the data needed for setting up loan and policy files.

Accordingly, the system 10 is an automated system that implements a lender-based insurance distribution model to produce several advantages, including but not limited to the below-listed advantages.
1) As mentioned above, lenders usually have the majority capital investment in the properties they finance. Lender-based insurance distribution allows the lenders to leverage their insurable interest in the insurance marketplace to provide their borrowers with a comprehensive, convenient, and competitive optional source for the required property insurance coverage needed to close the loan.
2) The automated system, which aggregates insurance risk based on the lender's underwriting of the credit risk, makes lender-based insurance distribution systems more efficient by reducing administrative costs, more profitable via reduced loss ratios, and less expensive for the consumer—up to about 25 percent lower rates.
3) The automated system allows insurers to determine their exposures to loss on a real-time basis. Coverage data provided to the insurer's catastrophe-modeling software improves the timeliness and quality of underwriting information, which in turn reduces uncertainty and risk-based costs.
4) Lender-based aggregation of risk provides larger lenders the option to participate in the underwriting results of their portfolio of insurance via reinsurance arrangements. Lender participation in the underwriting results may promote more responsible development in hazard prone coastal areas and earthquake zones.
5) An automated, mass-marketing approach to cross-selling between banking and insurance. Mortgage transactions that lenders make possible create an “instant of interest” that provides banks the opportunity to cross-sell personal and small commercial lines insurance to millions of consumers. The system 10 provides a multi-coverage part insurance policy designed for the lending industry to capitalize on this “instant of interest” created when a consumer obtains credit to re-finance an existing building, purchase an existing building, or construct a new building.

In the example embodiment described above, the builder's risk policy is initiated by a lender. In another example embodiment, the builder's risk policy is initiated by a builder so that the homebuilder is able to provide its home buyers less expensive homeowners coverage on their newly completed homes. For a builder-initiated policy request, for example, the initial coverage may be provided by a blanket builders risk policy written with a medium-sized or large homebuilder as the initial named insured and with new home buyer clients named as additional insureds under the terms of their purchase contract with the homebuilder. Builder's risk coverage provided in this way is disclosed in U.S. Patent Application Publication No. 2005/0086084 and commercially available through Omni Builders Risk, Inc. (Winder, Ga.) at “www.omnibuildersrisk.com,” which patent is hereby incorporated herein by reference.

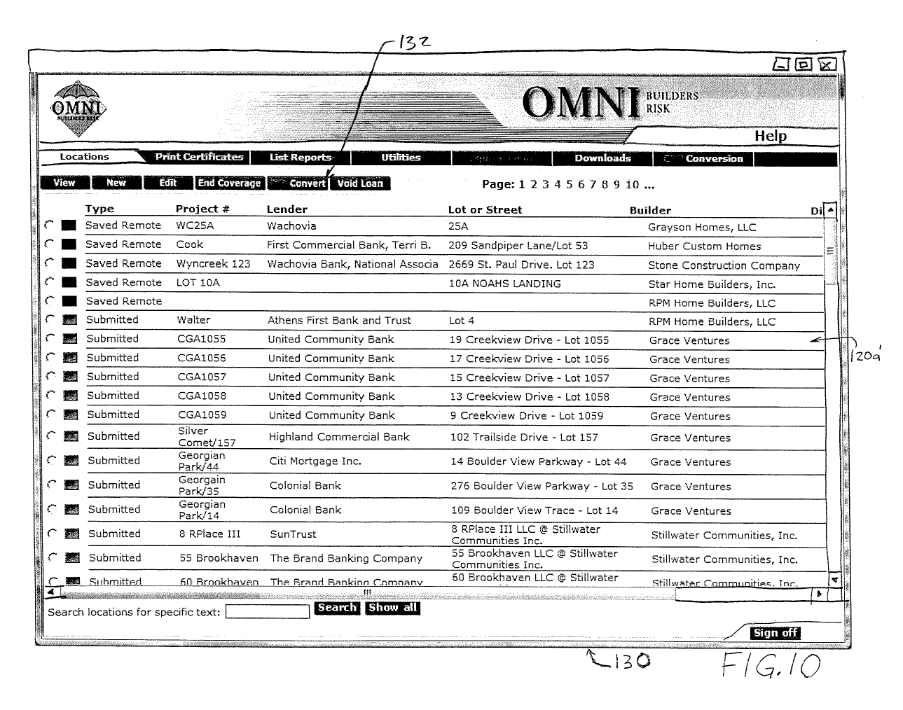

The system and method of this example embodiment are essentially the same as those described above and illustrated with reference to FIGS. 1-9. However, as shown at step 202 of the builder's risk intake method 200 of FIG. 2, the request for the builder's risk policy to be converted is initiated by a builder. Because the builders think of the policies as being associated with project locations instead of with loans (as the lenders do), about the only difference in this system is that it displays a “Locations” screen 130, an example of which is shown in FIG. 10, instead of the “List Loans” screen 30 of FIG. 5. Similarly to the “List Loans” screen, by selecting one of the location/policy files 120a′ and clicking the “View” button, the system displays details of the builder's risk policy for that location. And upon clicking on the “Convert” button 132 a “Convert Quote” screen is displayed to the online user, similarly to in the system and method described above. Thus, this conversion system and method is essentially the same as that described above.

While the above-described example embodiments provide a conversion system and method for insurance policies for residential real property, another example embodiment within the scope of the invention provides a conversion system and method for insurance policies for commercial real property. In such an embodiment, a commercial builder's risk insurance policy (also known as a “course of construction” or “COC” policy) is converted to a business-owner's policy (for smaller structures/risks) or a commercial multi-peril package policy (for larger structures/risks). As used herein, the term “builder's risk policy” includes insurance policies for the construction of residential, commercial, industrial, or mixed use structures on real property (or loans therefor). And as used herein the term “real property insurance policy” includes homeowner's insurance policies for residential structures on real property (or loans therefor), business-owner's policies and commercial multi-peril package policies for commercial and/or industrial structures on real property (or loans therefor).

It is to be understood that this invention is not limited to the specific systems, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A system for use by one or more lenders and one or more insurers to provide insurance for real property, comprising:
a server connected to a communications network and hosting a website that is accessible by network-connected user devices of the lenders and network-connected user devices of the insurers, the server storing files including information on a plurality of construction loans and permanent loans for the real property and on builder's risk insurance policies for the construction loans, the construction loans and permanent loans provided by the lenders, wherein the server receives from one of the user devices a selection of an active one of the builder's risk policies, the server communicates an underwriting request to one of the insurers, the server receives an approval from the underwriting insurer, and the server converts the selected builder's risk policy to a real property insurance policy for the real property by associating stored information from the builder's risk policy with the converted-to real property insurance policy.

2. The system of claim 1, wherein the server-saved information includes a first-named insured party and an additional-insured party for the selected builder's risk policy and a primary-named insured party and a lien holder for the real property insurance policy, the selected builder's risk policy's first-named insured party is the lender of the corresponding construction and permanent loans and the additional-insured party is a borrower of the corresponding construction and permanent loans, and as part of the conversion the server saves the borrower as the real property insurance policy's primary-named insured party and the lender as the lien holder.

3. The system of claim 1, wherein the server determines a pro-rated unearned premium amount for time remaining on the builder's risk policy, and as part of the conversion the server credits the unearned premium amount to a premium amount due for the real property insurance policy.

4. The system of claim 1, wherein the server assigns a first unique identifier to the selected builder's risk policy and as part of the conversion assigns a second unique identifier to the converted-to real property insurance policy, wherein the second unique identifier is correlated to the first unique identifier.

5. The system of claim 1, wherein the server receives a request communicated from one of the lender network-connected user devices to initiate the builders risk policy.

6. The system of claim 1, wherein the system further comprises network-connected user devices of a plurality of builders, and the server receives a request communicated from one of the builder network-connected user devices to initiate the builders risk policy.

7. The system of claim 1, wherein the server receives from one of the user devices a request to initiate a conversion of the selected policy to the real property insurance policy, and the server saves the files as pending real property insurance policy files after the conversion is requested until the conversion is complete.

8. A system for providing insurance for real property for use by a parent organization having a lending unit and an insurance unit, the system comprising:
a server connected to a communications network and hosting a website that is accessible by at least one network-connected user device of the lending unit and at least one network-connected user device of the insurance unit, the server storing files including information on a plurality of construction loans and permanent loans for the real property and on a blanket builder's risk insurance policy with a plurality of individual project location polices for the construction loans, with the construction loans, the permanent loans, and the individual project location polices provided by the lending unit, and with the blanket builder's risk policy provided by the insurance unit, each one of the construction loans and the corresponding one of the builder's risk project location policies being associated together on the server, wherein the server receives from one of the user devices a selection of an active one of the project location policies under the blanket builder's risk policy and a request to initiate a conversion of the selected policy to a real property insurance policy for the real property, the server communicates an underwriting request to the insurance unit, the server receives an approval from the insurance unit, and the server converts the selected policy to the real property insurance policy by associating stored information from the selected builder's risk project location policy with the converted-to real property insurance policy, wherein the server-saved information includes a first-named insured party and an additional-insured party for the selected policy and a primary-named insured party and a lien holder for the real property insurance policy, the selected builder's risk project location policy's first-named insured party is the lender of the corresponding construction and permanent loans and the additional-insured party is a borrower of the corresponding construction and permanent loans, and as part of the conversion the server saves the borrower as the real property insurance policy's primary-named insured party and the lender as the lien holder, and wherein the server saves the files as pending real property insurance policy files after the conversion is requested until the conversion is complete.

9. The system of claim 8, wherein the server determines a pro-rated unearned premium amount for time remaining on the builder's risk policy, and as part of the conversion the server credits the unearned premium amount to a premium amount due for the real property insurance policy.

10. The system of claim 8, wherein the server assigns a first unique identifier to the selected builder's risk policy and as part of the conversion assigns a second unique identifier to the converted-to real property insurance policy, wherein the second unique identifier is correlated to the first unique identifier.

11. The system of claim 8, wherein the server receives a request communicated from one of the lending unit network-connected user devices to initiate the builders risk policy.

12. The system of claim 8, wherein the system further comprises network-connected user devices of a plurality of builders, and the server receives a request communicated from one of the builder network-connected user devices to initiate the builders risk policy.

13. A method of providing insurance for real property, comprising:
receiving a request for a builder's risk policy on a construction loan for a building on the real property, the construction loan provided by a lender;
opening a file for the builder's risk policy and the construction loan;
communicating a request for underwriting for a real property insurance policy;
receiving an underwriting approval for a real property insurance policy; and
converting the existing builder's risk policy to a new real property insurance policy for the real property by associating stored information for the builder's risk policy with the converted-to real property insurance policy.

14. The method of claim 13, wherein the step of converting includes converting named-insured provisions by saving information on a borrower of the construction loan, which borrower was an additional-insured party on the builders risk policy, as a primary-named insured on the real property insurance policy, and saving information on a lender of the construction loan and of a new mortgage loan on the real property, which lender was a first-named insured on the builders risk policy, as a lien holder on the real property.

15. The method of claim 13, wherein the step of converting includes determining a pro-rated unearned premium amount for time remaining on the builder's risk policy, and crediting the unearned premium amount to a premium amount due for the real property insurance policy.

16. The method of claim 13, further including the step of assigning a first unique identifier to the builder's risk policy, and wherein the step of converting includes assigning a second unique identifier to the converted-to real property insurance policy, wherein the second unique identifier is correlated to the first unique identifier.

17. The method of claim 13, wherein the step of receiving a builder's risk policy request includes receiving a request for a builder's risk policy from the lender.

18. The method of claim 13, wherein the step of receiving a builder's risk policy request includes receiving a request for a builder's risk policy from a builder of the building.

19. The method of claim 13, further comprising initiating a time period within which the conversion must be completed.

20. A computer-readable medium storing instructions that, when executed on a programmed processor, carry out a method for providing insurance for real property, comprising:
instructions for processing a request for a builder's risk policy on a construction loan for a building on the real property, the construction loan provided by a lender;
instructions for associating information on the builder's risk policy with information on the construction loan;
instructions for communicating a request for underwriting for a real property insurance policy;
instructions for processing an underwriting approval for a real property insurance policy; and
instructions for converting the existing builder's risk policy to a new real property insurance policy for the real property by associating stored information for the builder's risk policy with the converted-to real property insurance policy.

21. The computer-readable medium of claim 20, wherein the instructions for converting further comprise instructions for converting named-insured provisions.

22. The computer-readable medium of claim 20, wherein the instructions for converting further comprise determining a pro-rated unearned premium amount for time remaining on the builder's risk policy, and crediting the unearned premium amount to a premium amount due for the real property insurance policy.
